(19) United States
(12) Patent Application Publication
(10) Pub. No.: US 2025/0346842 A1
(43) Pub. Date: Nov. 13, 2025

(54) FRACTIONS OF MALTED GRAINS AND THEIR SEPARATION PROCESS

(71) Applicant: UNIVERSIDAD AUTÓNOMA DE NUEVO LEÓN, Nuevo León (MX)

(72) Inventor: Leonardo CHÁVEZ GUERRERO, Nuevo León (MX)

(21) Appl. No.: 19/199,815

(22) Filed: May 6, 2025

(30) Foreign Application Priority Data
May 7, 2024 (MX) MX/A/2024/005553

(51) Int. Cl. C12C 1/16

(52) U.S. Cl. CPC C12C 1/16

(57) ABSTRACT

A process for separating malted grain fractions is described, which, through a single continuous processing stage with a single piece of equipment, allows the separation of a solid fraction of fragmented husk with low moisture content from the rest of its components and a semi-solid fraction that has available the smaller components originally contained in the bagasse, as well as the fractions obtained from such process.

### CROSS REFERENCE TO RELATED APPLICATIONS

This application is a non-provisional patent application and claims the benefit of Mexican Patent Application No. MX/a/2024/005553 filed on May 7, 2024, the contents of which are hereby incorporated by reference for all purposes.

### FIELD OF INVENTION

The present invention relates to techniques for recovering residues resulting from grain processing, and more particularly relates to the recovery of grain fractions that have been subjected to a malting process.

### BACKGROUND OF THE INVENTION

In general, the utilization of various grains involves processing them through various techniques, including milling, moistening, cooking, or a combination of these. However, except in cases where the purpose of grain processing is for consumption as food, in most processes involving grains, a significant solid fraction of the grain is recovered as residue. One of the most common processes of this type is malting, generally carried out using barley grain, particularly in the brewing industry.

Malting is a process applied to cereal grains that involves soaking, partial germination, and drying. The malting process is applied to various grains to ensure embryonic growth and enzyme synthesis, thereby ensuring and promoting the release of grain components that provide the characteristic organoleptic properties, primarily induced by phytochemical changes in the grain. (Molinari, R., Costantini, L., Timperio, A M, Lelli, V., Bonafaccia, F., Bonafaccia, G., and Merendino, N., Tartary buckwheat malt as ingredient of gluten-free cookies, Journal of Cereal Science, Vol. 80, March 2018, pp. 37-43).

Particularly in the brewing industry, the solid residue left behind as a byproduct of wort filtration is commonly referred to as brewers' spent grain (BSG). The large amount of BSG produced in this industry has prompted the search for alternatives for its treatment, containment, or reuse. The most common use of BSG has been as ruminant feed.

However, in the composition of malted beer bagasse (BCM) as a residue, a concentration of starch, cellulose and protein is appreciated, potentially of greater added value, which have been sought to be recovered for the establishment of industrial reuse processes (circular economy). More particularly, BSG has a higher concentration of minerals and a considerably lower caloric content. It has been reported that BSG has on average 41% fiber (cellulose), 18% protein and 10% starch mainly, so this residue (BCM) is appropriate for its use as a by-product of interest [Salanţă L C, et al., (2014). Brewers' spent grain—A new potential ingredient for functional foods. Journal of Agroalimentary Processes and Technologies 2014, 20(2), 137-141].

For this reason, various physical and chemical separation methods have been described in the state of the art for the use of BSG components.

As far as chemical treatments are concerned, acid hydrolysis is the most widely used method and can be used to obtain different types of by-products depending on the pre-treatments and subsequent processing.

These processes generally involve at least the incorporation of various stages to bring other inputs into contact with the BSG waste and change the chemical nature of its components, either for the removal of compounds such as lignin to obtain nanocellulose [Shahabi I. et al., (2014). Preparation and Characterization of Nanocellulose from Beer Industrial Residues Using Acid Hydrolysis/Ultrasound. Fibers and Polymers, Vol. 16, Issue 3, pp: 529-536], for the extraction of sugars and the removal of non-cellulosic material [Mishra P., et al., (2017). “BSG for cellulose nanofibers”, BioResources, Vol. 12, Issue 1, pp: 107-116], and other chemical hydrolysis processes oriented towards the preparation of residues as an input for the production of bioethanol [Romero I., et al., (2017). Brewer's spent grain valorization using phosphoric acid pretreatment for second generation bioethanol production. 25th Edition European Biomass Conference and Exhbition]; Mussato S., et al., (2013). “Techno-economic analysis for brewer's spent grains use on a biorefinery concept: The Brazilian case”, Bioresource Technology, Vol. 148, pp: 302-310; Broeker T., Steffens M., et al., (2011). P59 Delignification of brewery spent grains for bioethanol production. European Brewery Convention CONGRESS 20111. In general terms, chemical treatments require expensive and complex process equipment, significant energy requirements or consumption of auxiliary services, and also give rise to other waste that needs to be disposed of later, thus preventing the efficient use of BGM waste.

There are also physical treatments, such as that described in patent EP0694609A2, which describes an apparatus for disintegrating the remaining grain to expose certain components, by means of a multi-stage process of pressing the BSG on rollers with cutting edges, followed by screening. This process requires adjusting the initial moisture content of the BSG with the corresponding energy or water consumption, and in which the moisture content of the final product is presumably very high and the efficiency relatively low, as approximately 37% of the initial proteins are recovered, which constitute 50% of the dry weight of the recovered material. The entire liquid fraction is wasted, resulting in a final product still with a high moisture content.

Another physical process is the one described in U.S. patent Ser. No. 11/576,401B2, which requires multiple pieces of equipment and water consumption, and results in a product with a high moisture content. It also uses a vibratory sieve after grinding to reduce the material to a colloidal size, adding water up to 1:1 (water:BSG) to produce a paste that is processed in a screw press. The process results in two fractions, one containing the protein and another containing husks with 95% and 75% moisture, respectively. The protein is then mechanically filtered to remove any residual husks.

Another process that also involves sieving, handling of colloidal product and resulting products with high moisture content is U.S. patent Ser. No. 11/576,401B2, which describes a process to transform BSG into an edible suspension. The process involves a pretreatment of the BSG in a vibrating sieve (10-50 Hz), followed by grinding in a colloid mill with water until a mixture with the appearance of a homogeneous BSG paste is obtained, then it is passed through an extractor by means of an endless screw that grinds and separates the mixture into two fractions, an edible suspension with a moisture percentage above 90% and BSG husks with a moisture content of 60 to 75%.

For its part, patent WO2023099270A1 discloses that, using a cooking extruder, where the temperature, shear stresses and pressure are controlled, textured vegetable protein can be obtained. In this process, the BSG is also ground and then mixed with another source of vegetable protein (up to 40%) and subsequently passed through an extruder to homogenize the mixture and then cut and finally dry the material, which also has high humidity after the homogenization process. The patent is limited to BSG (5:24) and the materials should preferably be pre-mixed and hydrated before entering the extruder. In addition, the extruder is maintained at 150° C. (8:5) and a gas is added, preferably CO₂.

Similar techniques have been used for the extraction of other types of fractions from plant materials, such as saccharose from sugarcane juice, as described for example in patent GB1205947A. According to this document, the removal of liquid from the fibrous material of sugarcane bagasse is sought by means of an apparatus and process for extracting liquid from bagasse as a fibrous material. The apparatus includes a screw press having a plurality of rotating discs therein and arranged along a barrel that is divided into two sections to squeeze the liquid from the fibrous material and discharge it through an outlet in the last section of the apparatus, which allows the carriage of a large amount of components in the liquid fraction.

Other methods combine chemical and physical methods, which adds complexity to the treatment processes of BSG as a waste, as is the case of the process described by Yanhong He, et al., [Food and Bioproducts Processing 117 (2019) 266-274], where thawed BSG is ground in a disc mill to reduce the particle size, then mixed with deionized water to make a mixture with 5% (w/w) of total solids that is incubated together with sodium hydroxide, sodium bisulfite or the enzyme Alcalase respectively at 60° C. for 4 h, to help separate the protein from the fiber. The mixture is then sieved to separate the smaller proteins from the larger insoluble fibers and obtain two fractions, one high in protein (34.8 to 54.8%) and the other high in fiber (45.2 to 65.3%) depending on the reaction agent used. While this process allows for better targeting of fractions and their contents, it requires complex inputs and equipment.

The same happens with the process described by Berglund L. et al. who report a treatment of carrot juice bagasse and BSG [Berglund L., et al., (2016). Production potential of cellulose nanofibers from industrial residues: Efficiency and nanofiber characteristics. Industrial Crops and Products, Vol. 92, pp: 84-92; Siqueira G., et al., (2016). Re-dispersible carrot nanofibers with high mechanical properties and reinforcing capacity for use in composite materials. Composites Science and Technology, Vol. 123, pp: 49-56] and that affected the number of repetitions per step, where the main treatment is a physical method of ultrafine wet grinding, with equipment called MKCA6-3 super mass collider, Masuko Sangyo (specialized mill for the manufacture of cellulose nanofibers). In addition to sophisticated equipment, this treatment requires extraction of residual sugars and high-temperature alkaline treatment, as well as pH-controlled mixing and neutralization and final re-filtration, requiring, in the case of BSG, some steps to be repeated up to 3 times [Elovich M., (2016). “Chapter 9—Nanocellulose—fabrication, structure, properties, and application in the area of care and cure”, Fabrication and Self-Assembly of Nanobiomaterials, Vol. 1, pp: 243-288].

The above allows us to conclude that the treatment of materials derived from grain processing, particularly malted materials such as BSG, have been inefficient in obtaining independent fractions that can be used in industrial processes, particularly due to their high moisture content and/or low concentration of high added value components, or they require the use of complex substances and equipment that potentially generate more waste or require complex and expensive separation processes, also considering that the volume of BSG generated in industries such as brewing is of such a magnitude that batch processing of the waste is highly inefficient.

Therefore, it is necessary to obtain high-value-added fractions from processed grain residues without requiring complex equipment or multiple physical or chemical processing stages, and with low humidity, which also do not generate additional physical or chemical waste.

### OBJECTS OF THE INVENTION

It is an object of the present invention to obtain a substantially solid fraction (husk) of malted grains with low moisture content and high-weight internal components of the husk released and exposed for further treatment or separation.

It is another object of the present invention to obtain a semi-solid fraction of malted grains in which the low-weight components originally contained in the solid fraction are released without chemical processing and exposed for subsequent treatment or separation.

It is a further object of the present invention to obtain the solid and semi-solid fractions of malted grains by using a single equipment.

It is an additional object of the present invention to provide a continuous process for separating fractions of malted grains, which allows obtaining solid fractions (husk) with low moisture content and semi-solid fractions to process high volumes of malted grain.

### BRIEF DESCRIPTION OF THE FIGURES

The patent or application file contains at least one drawing executed in color. Copies of this patent or patent application publication with color drawing(s) will be provided by the Office upon request and payment of the necessary fee

FIG. 1 shows images of typical BSG obtained from the beer process, as a starting material, and images of the corresponding solid and semi-solid fractions, in accordance with the principles of the present invention, as well as images of other by-products such as maltose in water and protein with other aggregates obtained from the semi-solid fraction. FIG. 1a shows the starting material subjected to the process described in the present invention, FIG. 1b refers to a semi-solid fraction with an average moisture content greater than or equal to 70%, FIG. 1c refers to a solid fraction with a moisture content less than or equal to 20%, FIG. 1d) shows maltose with water (60.3% yield, with a maltose concentration of 6.75%) and Figure e) protein with other aggregates (39.02% yield, with a moisture percentage of 69.56%), both derived from the semi-solid fraction.

FIG. 2 shows a schematic representation of a preferred embodiment of equipment useful for use in accordance with the principles of the present invention, in which FIG. 2 a) represents an exploded view of the components of a slow masticating juicer equipment with press extractor, used for the continuous process of separating fractions of malted grains of the present invention, FIG. 2 b) represents a detailed view of the assembly of the components of the slow masticating juicer equipment with a press extractor and FIG. 2 c) represents a view of the slow masticating juicer equipment with a press extractor fully assembled.

FIG. 3 shows various scanning electron microscope views of the BSG before being subjected to the continuous process of separating malted grain fractions of the present invention and the solid and semi-solid fractions thereof in accordance with the present invention, corresponding to Test 1 of Example 1 of this description.

FIG. 4 shows various comparative low-resolution optical microscope views of the BSG of materials from Test 1 of Example 1 of this description to illustrate the starch contained in the husk before the process of the present invention (A) and the disintegrated state in the solid fraction of the present invention (B).

FIG. 5 consists of scanning electron microscopy (SEM) images showing in detail (nanometric scale) the semi-solid fraction of the present invention obtained from BSG and its components.

FIG. 6 shows a graph of the percentages of solids (husk) obtained with the process of the present invention with respect to time.

FIG. 7 shows photographs of fractions obtained in accordance with the principles of the present invention from unmalted wheat.

FIG. 8 shows images of malted wheat spent grain (MWSG) as a starting material, and images of the corresponding solid (a) and semi-solid (b) fractions, in accordance with the principles of the present invention, as well as images of other by-products obtained from the semi-solid fraction (c and d).

FIG. 9 shows comparative low-resolution optical microscope views of the MWSG to illustrate the starch contained in the husk before the process of the present invention (A) and the disintegrated state in the solid fraction of the present invention (B).

FIG. 10 shows high magnification photographs and scanning electron microscopy (SEM) images showing the semi-solid fraction of MWSG in detail.

### DETAILED DESCRIPTION OF THE INVENTION

It has been found that through a single continuous processing stage with a single piece of equipment it is possible to separate a solid fraction of fragmented husk with low moisture content from the rest of its components and a semi-solid fraction that has available the smaller components (that pass through the sieve) originally contained in the bagasse, starting from grains that have been subjected to a malting process.

According to the principles of the present invention, malting is understood to be the process comprising the treatment of a germinable plant grain by means of moisture, passing it through at least one soaking stage until its partial germination is achieved. The malting process is applied to various grains to ensure, through its stages, embryonic growth and enzyme synthesis, thus ensuring and promoting the release of grain components that provide the characteristic organoleptic properties induced mainly by phytochemical alterations in the grain.

Consequently, the process of the present invention is carried out using any maltable grain or an equivalent process that allows obtaining the same organoleptic properties. More particularly, the malted grain is selected from barley, rice, rye, wheat, and oats, although malted barley brewers' spent grain (BSW) is most preferably used.

The continuous separation process of the present invention is characterized in that it comprises subjecting brewers' spent grain from malted grains to a continuous multi-stage extrusion process that allows grinding of the spent grain to recover a filtered semi-solid fraction of the malted grains with a minimum moisture content of 70% and a solid fraction of the extruded malted grains with a maximum moisture content of 30%.

In a preferred embodiment of the present invention, the multi-stage extrusion consists of grinding the spent grain from the malted grains by means of an endless screw that exerts variable mechanical pressure, depending on the length and angle of the passage of the endless screw, on a filtering press sieve to recover the semi-solid fraction of the grains as material filtered by the filtering sieve while the solid fraction of the grains is extruded advancing through the endless screw.

The characteristics of the solid and semi-solid fractions of the spent grain from malted grains of the present invention are also novel.

Preferably, the solid fraction of the present invention is characterized by having a maximum moisture content of 25% without having been subjected to a drying process, preferably a maximum moisture content of 20%, and more preferably a maximum moisture content of 13.45%.

The solid fraction of the present invention preferably comprises structural cellulose from the husk and a low concentration of free starches, the size of which depends on the grain used, more preferably free starches with sizes greater than 2 μm, preferably between 2 and 20 μm.

As regards the semi-solid fraction of malted grains of the present invention, it is characterized in that it has a moisture of at least 70% and comprises small-sized components originally contained in the solid fraction released, without chemical processing, and available for subsequent treatment or separation.

In a preferred embodiment, the semi-solid fraction of malted grains of the present invention comprises remnant starch of 2 μm or less, nanocellulose nanoparticles, spherical and hemispherical particles of proteins and starch, and maltose.

In a preferred embodiment of the continuous separation process, the spent grain from malted grains is subjected to extrusion immediately upon completion of its malting process, preferably at a temperature between 6° and 80° C.

In another preferred embodiment of the continuous separation process of the present invention, the extrusion is carried out by means of a single extrusion equipment with a filtration screen comprising an outlet path for the semi-solid fraction that directs the filtrate that passes through the filtration screen for collection and an outlet path for the solid fraction that forms an extruded solid material for collection.

For the purposes of the present invention, multi-stage extrusion is understood to mean an extrusion in which the filter press screen comprises a variable, decreasing pore size, while the screen on the spent grain from malted grains feed side has a larger pore size than that on the solids fraction outlet side. In a preferred embodiment of the present invention, the extrusion is carried out at a speed between 50 and 110 rpm.

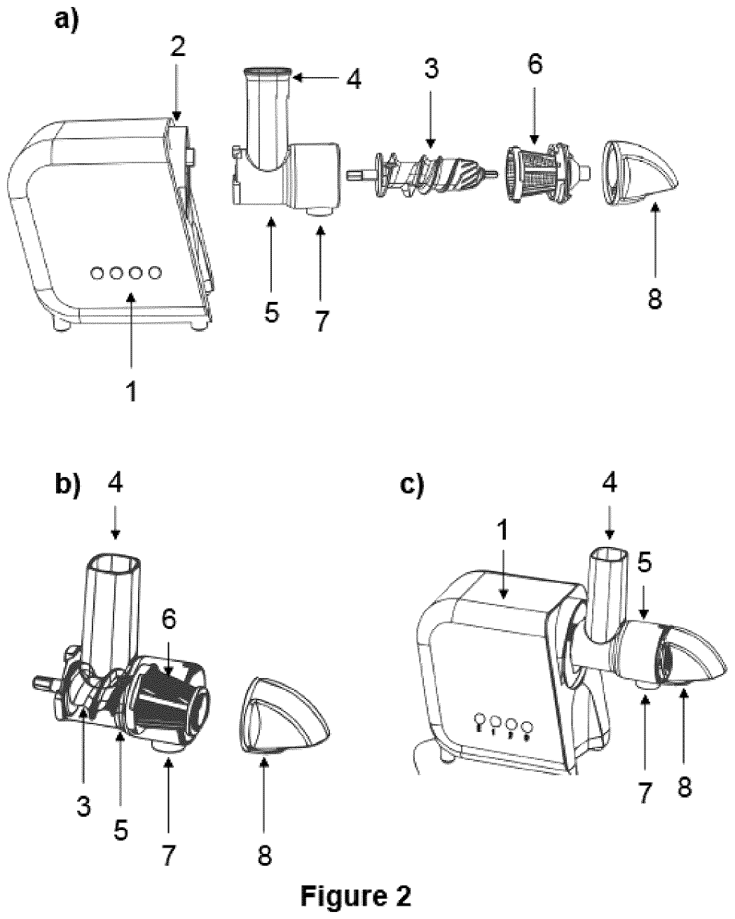

The continuous separation process of the present invention will be better understood in relation to an embodiment of equipment useful for multi-stage extrusion such as that shown in FIG. 2. A person skilled in the art will be able to identify various pieces of equipment useful for carrying out extrusion under the required conditions. However, FIG. 2 illustrates equipment for multi-stage extrusion known as a slow masticating juicer with a press extractor. FIG. 2 shows a view of the slow masticating juicer with a press extractor and the elements comprising it. In relation to said figure, as described above, the process comprises introducing the spent grain from malted grains into the extruder as shown in FIGS. 2b and 2c. FIG. 2 itself provides a better understanding of how to put the process of the present invention into practice using a single piece of equipment, since FIG. 2 a) shows an exploded perspective view of the components of the multi-stage extruder whose embodiment is described. The multi-stage extrusion equipment, called slow masticating juicer with press extractor of the preferred embodiment illustrated in FIG. 2, comprises a main body (1) that houses an internal motor (2) to which an endless screw (3) is coupled, in an arrangement such that said endless screw (3) is capable of rotating horizontally when the internal motor (2) is actuated at a speed between 50 and 110 rpm. The equipment in FIG. 2 also has a feed orifice (4) through which malted grain is entered, which is directed to a chamber (5) with a substantially cylindrical body, and where the chamber (5) is crossed by the endless screw (3) which, when rotating, presses the malted grain against a substantially conical sieve with decreasing pore size (6) with the largest diameter located at the start of the endless screw (3) and where the sieve is located at the opposite end to the junction of the endless screw (3) with the internal motor (2) covering it up to the middle part of its length. By actuating the internal motor (2), the endless screw pushes the spent grain introduced through the feed orifice (4), and by means of the pressure exerted by the endless screw (3) on the spent grain against the cylindrical sieve with decreasing pore size (6) the smallest components exit through the pores of the cylindrical sieve with decreasing pore size (6) perpendicular to the movement of the endless screw (3) to recover a semi-solid fraction that is expelled from the equipment through an outlet orifice (7), while the largest components are directed to the outlet of the cylindrical sieve with decreasing pore size (6) and are conducted horizontally towards an outlet duct for the solid fraction (8). In the illustrated embodiment, the equipment is completely removable and preferably has a power of 0.5 HP and a consumption of 150-300 W, the pore size of the substantially conical sieve varies along its length and allows the passage of particles from 8 nm to 2 μm, for example in one embodiment of the invention a sieve with a pore size of 2 to 0.6 mm is used, however, this may vary based on the extraction needs and the particle size of the recovered fractions and their components.

The process of the present invention has an efficiency greater than 99% in the recovery of the fractions processed as a whole. Preferably, the percentage loss in obtaining the semi-solid and solid fractions of the initial material, i.e., the shrinkage, is less than 0.6%, which is indicative of an efficient fraction recovery process.

In accordance with the principles of the present invention described above, it is evident to a person skilled in the art that the spent malted grain fractions obtained by the process of the present invention have unique characteristics that have never been achieved in the prior art in a single process step, and that the results obtained are achieved thanks to the manner in which the separation is carried out. However, the present invention will be better understood for putting it into practice by means of the following examples, which are illustrative but do not limit the scope of the claimed invention.

### Example 1. Continuous Multi-Stage Extrusion Process of Brewer's Spent Grain

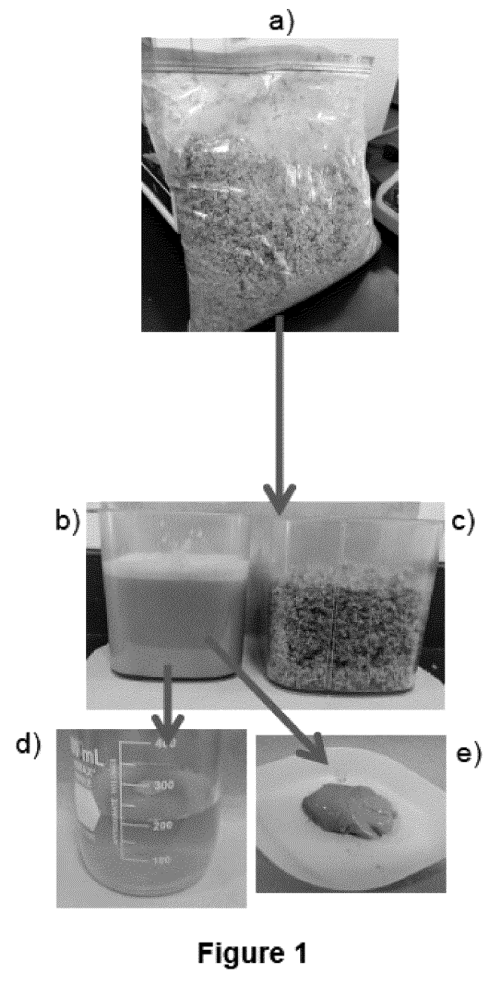

To illustrate the realization of the continuous multi-stage extrusion process, brewer's spent grain (BSG) at a temperature between 60° C. to 80° C. obtain from a beer production process (FIG. 1(a)) was subjected to the multi-stage extrusion process in equipment such as that illustrated in FIG. 2. Due to the characteristics of the process, the BSG was processed continuously, stopping the process only to clean the cylindrical sieve with decreasing pore size (6) of the equipment.

The process was carried out in duplicate by varying the source of the brewers' spent grain (BSG), with Test 1 being a BSG from an artisanal brewing process, and Test 2, a BSG from a large-scale beer production process was used, in order to verify whether the specific malting process has an effect on the present invention. Once each of the samples had been subjected to the separation process described above, two fractions were obtained per test, a semi-solid fraction (FIG. 1b) with an average moisture content greater than or equal to 70% and a solid fraction (FIG. 1c) with a moisture content less than or equal to 20%. The percentage of moisture was determined by weighing each fraction to determine its total weight, and subsequently each fraction was dried at 60° C. for 12 hours, and the difference between the initial weight with water and the final weight after drying was determined. The results per test are shown in Table 1.

TABLE 1
16. Results obtained from the process described
in the present invention with two BSG samples.

| 1. | 2. Test 1 | 3. Test 2 |
|---|---|---|
| 4. Percentage of semi-solid fraction | 5. 60.4% | 6. 84.26% |
| obtained | | |
| 7. Moisture content of semi-solid fraction | 8. 82% | 9. 70% |
| 10. Percentage of solid fraction obtained | 11. 39.2% | 12. 15.54% |
| 13. Moisture content of solid fraction | 14. 20% | 15. 25% |

Table 1 shows that the percentage of loss in obtaining the semi-solid and solid fractions of the initial material, that is, the shrinkage, is less than 0.6%, which is indicative of an efficient fraction recovery process.

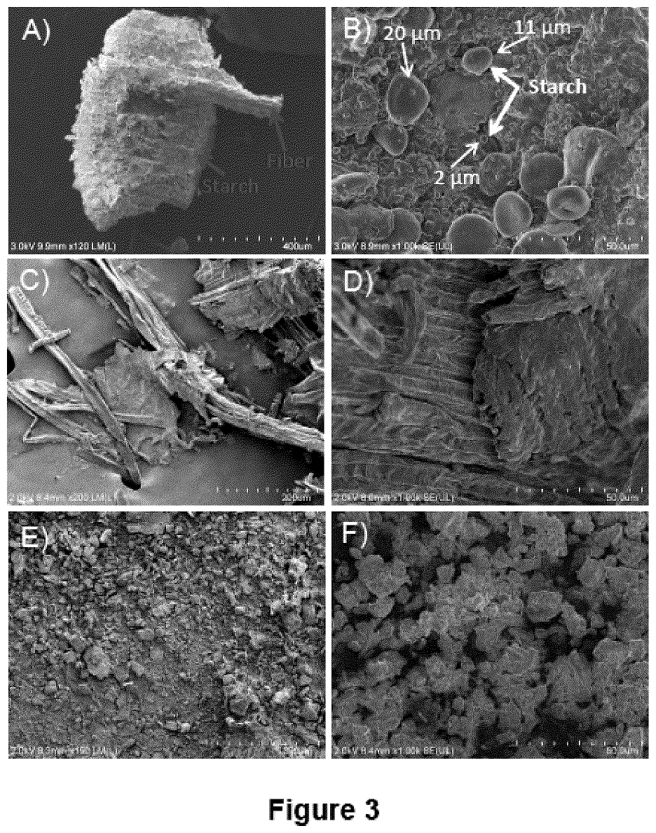

Samples of the semi-solid fraction and the solid fraction from Test 1 were taken and observed under the scanning electron microscope after the multi-stage extrusion process, whose images are presented in FIG. 3, which displays the appearance of A) and B) untreated BSG, of C) and D) a sample of the solid fraction obtained in Test 1 of this Example 1 and of E) and F) a sample of the semi-solid fraction obtained in Test 1 of this Example 1 can be seen, where the appearance can be seen in A) and B) the untreated spent grain at 120× and 1000×, respectively, in C) and D a sample of the solid fraction at 200× and 1000×, respectively, and in E) and F) a sample of the semi-solid fraction at 150× and 1000×, respectively.

FIG. 3A) shows a fiber attached to the cell wall, which in turn contains the starches in a protein network. FIG. 3B) shows the large starches (□10-20 μm) and small starches (□2-4 μm) in detail and with their characteristic shape. FIGS. 3C-D) show details of the fibers, with different shapes, which mainly contribute cellulose as part of the solid fraction, while FIGS. 3E-F) show how the structure is completely broken down after the process, releasing the starches and other components trapped in the protein matrix. Likewise, the BSG of Test 1 prior to the process and the solid fraction obtained by the process before and after the multi-stage extrusion process were observed under a low-resolution optical microscope, whose images are shown in FIG. 4. In FIG. 4A) the starch (arrow) can be seen in its original position still within the malted grain, while in FIG. 4B) the solid residue (husk) is shown, where it can be seen how the BSG completely disintegrates to release its internal components.

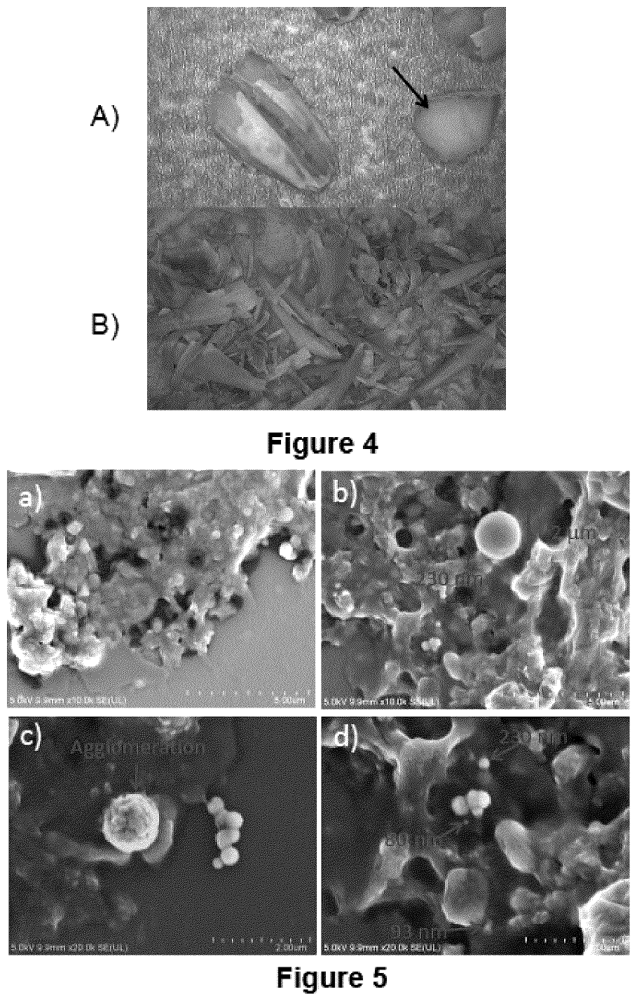

Additionally, to confirm the components of the semi-solid fraction, SEM images were obtained showing in detail (nanometric scale) the semi-solid fraction obtained from the process described in the present invention on the BSG, which are presented in FIG. 5, and where it can be seen that it is mainly composed of remaining starch (□□2 μm), nanocellulose nanoparticles, spherical and hemispherical particles of proteins and starch, and maltose. The images in FIGS. 5A) and 5B) show different areas of the semi-solid fraction at 10,000×, while FIGS. 5C) and 5D) show different areas of the semi-solid fraction at 20,000×.

### Example 2. Humidity and Drying Time of the Solid Fraction

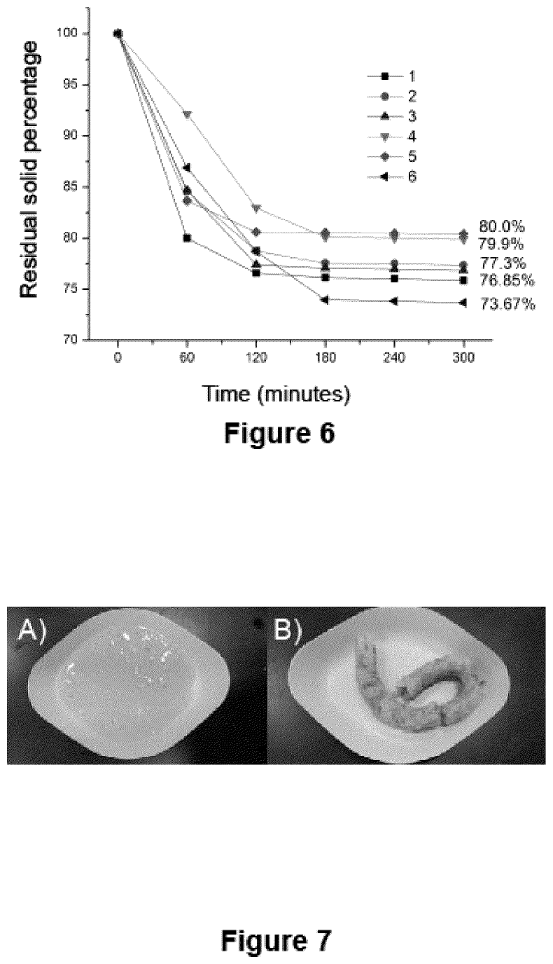

To corroborate the moisture content of the fractions and their drying kinetics, six repetitions (series 1 to 6 in FIG. 6) of the continuous multi-stage extrusion process of Test 1 of Example 1 (BSG from a craft brewing process) were performed. The results are shown in FIG. 6, where 100% of the solid fraction is obtained at 0 minutes, and as the moisture is removed from the solid fraction, the material was weighed to determine the weight difference (water loss) based on the percentage of residual solids in the solid fraction, in order to measure its variation with respect to time. It can be seen that the percentage of residual solids is 73.67% to 80%, just after 180 minutes, for the 6 repetitions performed. Therefore, the moisture percentage can be considered to be 20-27% in the solid fraction and that it can be easily removed if desired. This is of particular interest if you want to burn the solid to reduce its volume or if you want to use it as fuel.

On the contrary, when trying to dry the BSG without treatment directly (60-70° C.), maltose and starch prevent rapid drying, as reported by Jaqueline Andrea Custódio Trevizan, et al, 2021, where they use a drying method at 70° C. for 38 hrs, obtaining a fraction with a humidity percentage less than 5% (Jaqueline Andrea Custódio Trevizan, et al, 2021. Nutritional Composition of Malted Barley Residue from Brewery. Journal of Management and Sustainability; Vol. 11, No. 1; 2021. ISSN 1925-4725 E-ISSN 1925-4733). These direct drying techniques of BSG are what the brewing industry currently does, however, these require a large energy consumption, both for drying and burning, so applying the process of the present invention to BSG (separation) brings an immediate benefit in the reduction of processing and drying time and energy for subsequent use or burning with respect to heat drying methods. Likewise, some physical methods are proposed as an alternative, for example, the one presented by Bruna Muriel F. Costa, et al, 2020, where they only managed to remove 26.64% of humidity when using a pressing technique with a BSG worm screw (Chemical Industry and Chemical Engineering Quarterly 2020 Volume 26, Issue 4, Pages: 369-376, https://doi.org/10.2298/CICEQ190827014C), so the present invention again represents an important advantage, in this case, with respect to the percentage of humidity that the solid fraction has, managing to remove up to 80% of humidity from the initial sample.

### Example 3. Obtaining Byproducts from the Semi-Solid Fraction

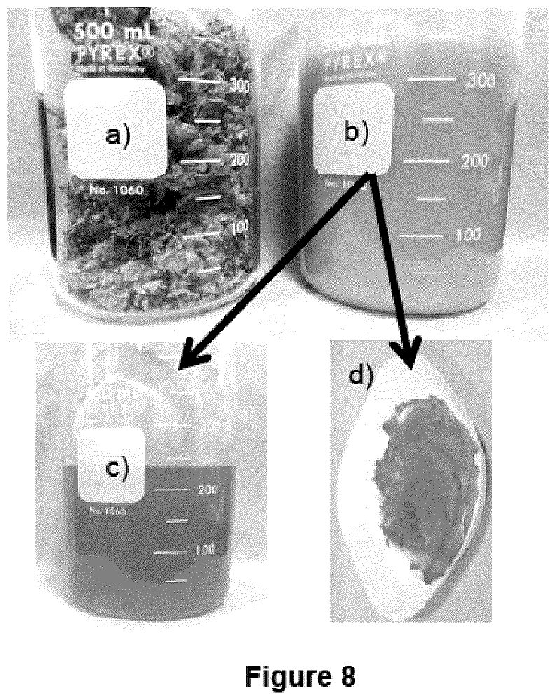

Optionally, the semi-solid fraction can be further treated by separating the liquid from the suspended matter. One way to do this is to centrifuging, filtering, or decanting the semi-solid fraction, thereby obtaining a solid containing protein and other aggregates, and a liquid containing maltose and water. Specifically, in the case of the BSG in this example, byproducts from the semi-solid separation fraction were obtained, as shown in FIG. 1, after centrifugation was carried out in an ultracentrifuge at 9,500 rpm for 15 min. The following were obtained: d) maltose with water (60.3% yield, with a maltose concentration of 6.75%) and e) protein with other aggregates (39.02% yield, with a moisture content of 69.56%). The appearance of these elements can be observed in FIG. 1(d) for the liquid and FIG. 1(e) for the solid. However, the same process can be performed with other grains, for example, wheat, and similar results can be obtained, as shown in FIG. 8(cd). Therefore, it can be considered a generic result using the process described above (centrifugation).

### Example 4. Multi-Stage Continuous Extrusion Process with Ungerminated (Unmalted) Wheat

In order to illustrate the importance for the present invention of using malted grains as a starting material, an example was carried out using the process of the present invention, but starting from unmalted wheat grains. To do this, wheat grains were heated to 80° C. for 5 h, and the afore mentioned extrusion process was applied, but without separation as in the case of malted grain, since it has not been exposed to enzymatic attack and the physicochemical effects this entails. It is known, for example, that biomass exposed to enzymes allows the conversion of starch into sugars, decreasing viscosity, which has an effect on the separation of fractions. The result is shown in FIG. 7A, where the “semi-solid” portion can be seen, but it is mostly composed of starch, making it too viscous and difficult to pass through the sieve integrated into the screw conveyor. For its part, in FIG. 7B) the solid or husk can be seen, but it maintains a high level of starches (whitish color), which shows that the properties are totally different and the separation does not allow obtaining fractions with the characteristics of the fractions of the present invention. The white color of the sample in FIG. 7A) is a clear indication of the lack of maltose, which is logical since there are no enzymes that can convert starch into maltose.

### Example 5. Continuous Multi-Stage Extrusion Process of Pre-Processed Wheat (Malted Type)

To demonstrate that the present invention does not work with just one grain, 200 g of wheat grains are soaked in water for 24 hours. They are then transferred to a container and spread evenly over the surface. Care must be taken to keep the wheat grains hydrated in order to promote germination (according to the technique already known in the art of germination). Once the germination reaches three-quarters of the grain (approximately 5 mm), germination is stopped using any drying method (24 h at 60° C.). The grain is then crushed in a roller mill (or any other method established, for example, in breweries) and the “broken” grains are emptied into a container with water (2:1). The mixture is then stirred at 300 rpm for 48 h at 60° C. to promote the conversion of starches into sugars. Once this time has passed, the mixture is passed through the process described in the present invention to obtain the separation of the semi-solid fraction and the solid fraction, obtaining the results shown in FIG. 8 and in Table 3.

FIG. 8 shows fractions obtained from brewer's spent wheat grain (BSWG) in its “fresh” state, just collected after the enzymatic treatment described above, where FIG. 8 (a) shows the solid fraction (8.38%) and FIG. 8 (b) shows the semi-solid fraction (88.78%) resulting from the separation of BSWG through the process described in the present invention. Additionally, the byproducts of the semi-solid separation fraction (centrifugation, in an ultracentrifuge at 9500 rpm for 15 min) are shown after being subjected to other treatments, where (c) maltose with water (≈81.19%) and (e) protein with other aggregates (18.81%) can be obtained directly from the semi-solid fraction.

TABLE 3
27. Results obtained from the process described
in the present invention with two wheat samples.

| 17. | 18. Test 1 |
|---|---|
| 19. Percentage of semi-solid | 20. 88.78% |
| fraction obtained | |
| 21. Moisture content of semi- | 22. 74% |
| solid fraction | |
| 23. Percentage of solid | 24. 8.38% |
| fraction obtained | |
| 25. Moisture content of solid | 26. 13.45% |
| fraction | |

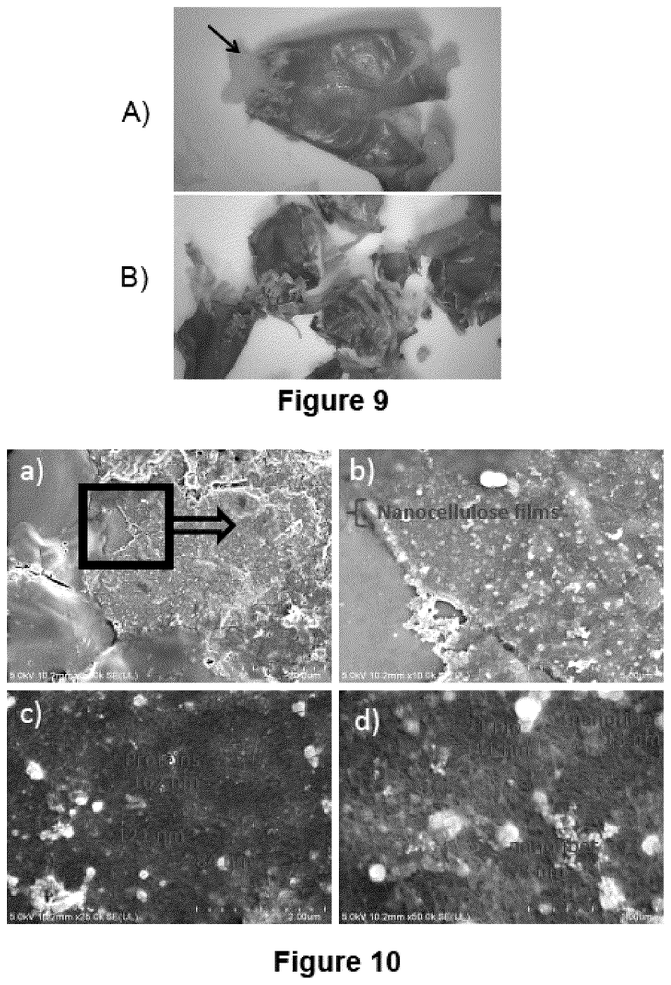

The above demonstrates that the process described here is not exclusive to BSG, but can be used with any type of germinated grain exposed to conversion enzymes. Likewise, the BSWG of test 1 prior to the process and of the solid fraction obtained by the process were observed under a low-resolution optical microscope. In FIG. 9A), starch (arrow) can be seen in its original position still within the BSWG, while in FIG. 9B), in the solid fraction (husk), it can be seen how the BSWG completely disintegrates to release its internal components. In FIG. 10, scanning electron microscopy (SEM) images can be seen, indicating the presence of nanocellulose sheets (ab) (thickness 80-250 nm) composed of cellulose nanofibers (□□6-18 nm) and nanoparticles (□□20-160 nm) (cd), mainly protein nanoparticles, thereby demonstrating the effect of the process on the biomass and its ability to produce particles at the nanometric scale by separating the different elements originally contained in the malted grains (barley, wheat, etc.). In accordance with the above, it will be apparent to any person skilled in the art that the present invention gives rise to solid and semi-solid fractions of spent malted grain with advantageous characteristics with respect to what can be obtained from the state of the art, and that there may be variations in the starting equipment or grains, as long as the principles described for the present invention and claimed in the appended claims are followed.

1. A continuous process for the separating of fractions from spent malted grains, characterized in that it comprises subjecting spent malted grains to a continuous multi-stage extrusion process that allows the recovery of a filtered semi-solid fraction of the malted grains with a minimum moisture of 70% and a solid fraction of the extruded malted grains with a maximum moisture of 30%.

2. The continuous process for separating fractions of malted grains, according to claim 1, further characterized in that it has an efficiency greater than 99% in the recovery of fractions of the malted grains as a whole.

3. The continuous process of separating fractions of malted grains, according to claim 2, further characterized in that the percentage of loss in obtaining the fractions of the initial material is less than 0.6%.

4. The continuous process of separating fractions of malted grains, in accordance with claim 1, further characterized in that it is carried out from any grain susceptible to malting, or from an equivalent process that allows obtaining the same organoleptic properties.

5. The continuous process of separating fractions of malted grains, according to claim 1, further characterized in that the grain is selected from barley, rice, rye, wheat and oats.

6. The continuous process for separating fractions of malted grains, according to claim 5, further characterized in that the process is carried out from spent malted barley grain (SMBG).

7. The continuous process for separating fractions of malted grains, according to claim 1, further characterized in that the extrusion is carried out by means of a single extrusion equipment with a filtration sieve comprising an outlet path for the semi-solid fraction that directs the filtrate that passes through the filtration sieve for collection and an outlet path for the solid fraction that forms an extruded solid material for collection.

8. The continuous process for separating fractions of malted grains, according to claim 7, further characterized in that the multi-stage extrusion consists of grinding the spent malted grains by means of an endless screw that exerts variable mechanical pressure, depending on the length and angle of the passage of the endless screw, on a filtration sieve press to recover the semi-solid fraction of the grains as material filtered by the filtration sieve while the solid fraction of the grains is extruded advancing through the endless screw.

9. The continuous process for separating fractions of malted grains, according to claim 1, further characterized in that the spent malted grains are subjected to extrusion immediately upon completion of its malting process, preferably at a temperature between 6° and 80° C.

10. The continuous process for separating fractions of malted grains, according to claim 1, further characterized in that the extrusion is carried out at a speed between 50 and 110 rpm.

11. A fraction of malted grains characterized by up to 30% moisture content; structural cellulose from the husk; and a low concentration of free starches.

12. The malted grain fraction according to claim 11, further characterized in that the free starches have sizes greater than 2 μm.

13. The malted grain fraction according to claim 12, further characterized in that the free starches have sizes of up to 20 μm.

14. The malted grain fraction according to claim 11, further characterized in that it has a maximum humidity of 20%.

15. A fraction of malted grains characterized by comprising at least 70% moisture and low-size components released from the malted grains available for further separation.

16. The malted grain fraction according to claim 15, further characterized in that the small-sized components comprise starch of maximum 2 μm, nanocellulose nanoparticles, spherical and semi-spherical particles of proteins and starch, and maltose.
